(19) United States
(12) Patent Application Publication
(10) Pub. No.: US 2017/0310034 A1
(43) Pub. Date: Oct. 26, 2017

(54) Dispenser With An Open Cover Detector

(71) Applicant: Betco Corporation, Bowling Green, OH (US)

(72) Inventors: Andrew M. Pate, Bowling Green, OH (US); Jacob T. Weil, Toledo, OH (US)

(73) Assignee: Betco Corporation, Bowling Green, OH (US)

(21) Appl. No.: 15/419,201

(22) Filed: Jan. 30, 2017

Related U.S. Application Data
(60) Provisional application No. 62/325,483, filed on Apr. 21, 2016.

(51) Int. Cl. H01R 13/22; E06B 7/28

(52) U.S. Cl. CPC H01R 13/22; E06B 7/28

(57) ABSTRACT

An open cover detector for a dispenser is provided. The open cover detector includes a cathode connector electrically connected to a cathode of a dispenser power supply and an anode connector electrically connected to an anode of a dispenser power supply. A bridge is configured to electrically connect the cathode connector to the anode connector with a dispenser cover in a closed orientation and further configured to electrically disconnect the cathode connector from the anode connector with a dispenser cover in an open orientation.

### CROSS-REFERENCE TO RELATED APPLICATION

This application claims the benefit of U.S. Provisional Application No. 62/325,483, filed Apr. 21, 2016, the disclosure of which is incorporated herein in its entirety by reference.

### BACKGROUND

Dispensing devices can be used in facilities and industries for storing and dispensing all forms of liquids, solids and powders. One non-limiting example of a dispensing device is a device for dispensing hand cleaning liquid. The complexity of dispensing devices can range from simple enclosures having manual dispensing mechanisms to cutting edge technology enclosures equipped with sensors configured to sense the presence of an object and dispense a liquid, solid and/or powder in response to the sensed object.

Dispensers can have one or more rotatable covers and/or doors that allow entry into and access to the interior portions of an enclosure. Access is desirable to refill reservoirs containing the dispensed liquids, solids and powders. Access is also desirable for periodic service to the dispensing apparatus.

It would be advantageous if access to the interior portions of a dispenser would render the dispenser inoperative.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the open cover detector for a dispenser.

The above objects as well as other objects not specifically enumerated are achieved by an open cover detector for a dispenser. The open cover detector includes a cathode connector electrically connected to a cathode of a dispenser power supply and an anode connector electrically connected to an anode of a dispenser power supply. A bridge is configured to electrically connect the cathode connector to the anode connector with a dispenser cover in a closed orientation and further configured to electrically disconnect the cathode connector from the anode connector with a dispenser cover in an open orientation.

The above objects as well as other objects not specifically enumerated are also achieved by a method of operating an open cover detector for a dispenser. The method includes the steps of electrically connecting a cathode connector to a cathode of a dispenser power supply, electrically connecting an anode connector to an anode of the dispenser power supply, closing a dispenser cover, the dispenser cover having a bridge, such that the bridge electrically connects the cathode connector to the anode connector and opening the dispenser cover such that the bridge electrically disconnects the cathode connector from the anode connector.

The above objects as well as other objects not specifically enumerated are also achieved by a dispenser incorporating an open cover detector. The dispenser includes a dispenser base configured to support a dispenser power supply and a dispenser cover connected to the dispenser base. The dispenser cover is configured for pivoting movement in a direction away from the dispenser base thereby forming an open orientation and further configured for pivoting movement in a direction toward the dispenser base thereby forming a closed orientation. An open cover detector is configured to engage the dispenser power supply with the dispenser cover in the closed orientation and further configured to disengage the dispenser power supply with the dispenser cover in an open orientation. The open cover detector includes a cathode connector electrically connected to a cathode of a dispenser power supply and an anode connector electrically connected to an anode of a dispenser power supply. The open cover detector further includes a bridge configured to electrically connect the cathode connector to the anode connector with a dispenser cover in the closed orientation and further configured to electrically disconnect the cathode connector from the anode connector with a dispenser cover in the open orientation.

The above objects as well as other objects not specifically enumerated are also achieved by a method of operating a dispenser. The method includes the steps of supporting a dispenser power supply within a dispenser base, connecting a dispenser cover to the dispenser base and configuring the dispenser cover for pivoting movement in a direction away from the dispenser base thereby forming an open orientation and further configuring the dispenser cover for pivoting movement in a direction toward the dispenser base thereby forming an closed orientation, positioning the dispenser cover in the closed orientation thereby engaging the dispenser power supply with an open cover detector and positioning the dispenser cover in the open orientation thereby disengaging the dispenser power supply with the open cover detector.

Various aspects of the open cover detector for a dispenser will become apparent to those skilled in the art from the following detailed description, when read in light of the accompanying drawings.

### BRIEF DESCRIPTION OF THE DRAWINGS

FIG. 1 is a perspective view of a dispenser.

FIG. 2 is a perspective view of the dispenser of FIG. 1, shown with a dispenser cover in an open orientation.

FIG. 3 is a front view, in elevation, of the dispenser of FIG. 1, shown with a dispenser cover in an open orientation.

FIG. 4 is a front view, in elevation, of the dispenser of FIG. 1 shown with a dispenser cover in an open orientation.

FIG. 5 is a front view, in elevation, of a portion of the dispenser of FIG. 1, illustrating a power supply.

FIG. 6 is a front view, in elevation, of a portion of the power supply of FIG. 5, illustrating a cathode portion and an anode portion.

FIG. 7 is a perspective view of a portion of the power supply of FIG. 5, illustrating engagement by a bridge.

FIG. 8 is a front view, in elevation, of a portion of the power supply of FIG. 5, illustrating a bridge engaging the cathode portion and anode portion.

FIG. 9 is a perspective view of a portion of the power supply of FIG. 5, illustrating a bridge engaging the cathode portion and anode portion.

### DETAILED DESCRIPTION

The dispenser with an open cover detector (hereafter “dispenser”) will now be described with occasional reference to specific embodiments. The dispenser may, however, be embodied in different forms and should not be construed as limited to the embodiments set forth herein. Rather, these embodiments are provided so that this disclosure will be thorough and complete, and will fully convey the scope of the dispenser to those skilled in the art.

Unless otherwise defined, all technical and scientific terms used herein have the same meaning as commonly understood by one of ordinary skill in the art to which the dispenser belongs. The terminology used in the description of the dispenser herein is for describing particular embodiments only and is not intended to be limiting of the dispenser. As used in the description of the dispenser and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the dispenser. Notwithstanding that the numerical ranges and parameters setting forth the broad scope of the dispenser are approximations, the numerical values set forth in the specific examples are reported as precisely as possible. Any numerical values, however, inherently contain certain errors necessarily resulting from error found in their respective measurements.

The description and figures disclose a dispenser incorporating an open cover detector. Generally, the cover of the dispenser is rotatable from a closed orientation to an open orientation. With the cover in an open orientation, the open cover detector is configured to sense the open orientation of the cover and render the dispenser inoperative. The term “dispenser”, as used herein, is defined to mean any container for dispensing a material.

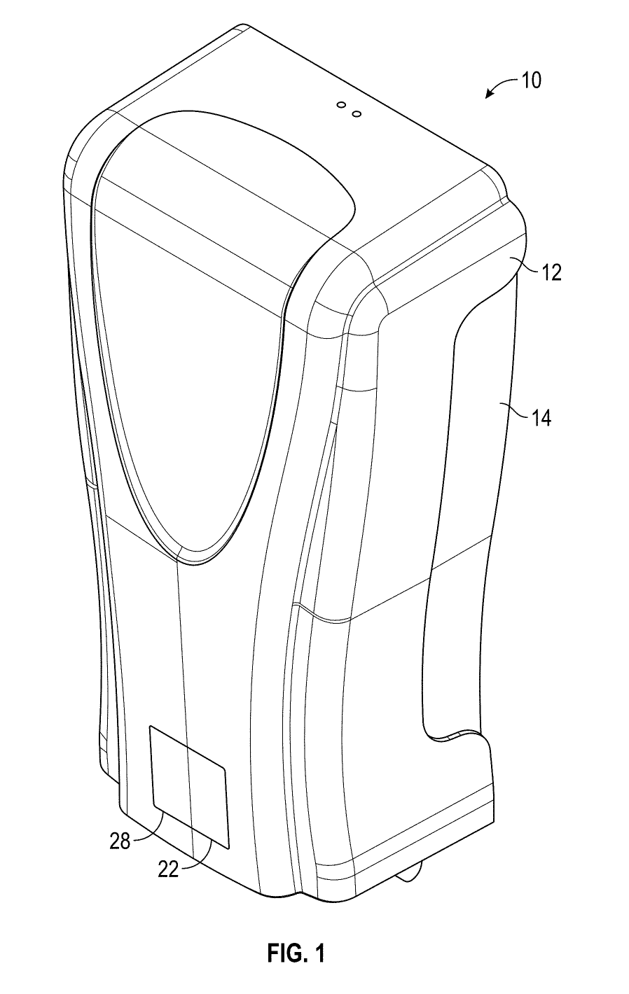

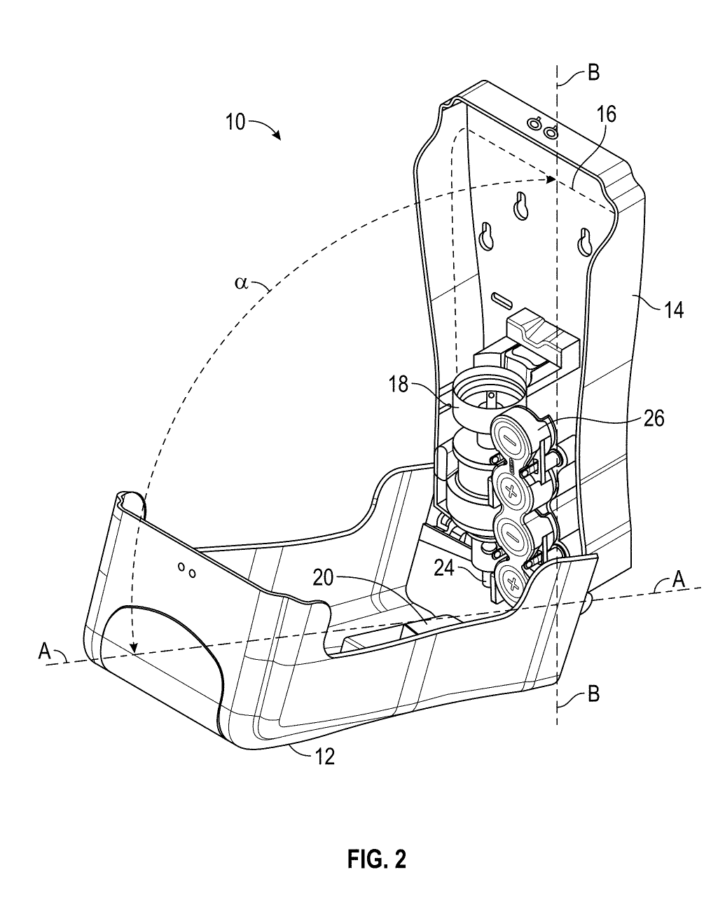

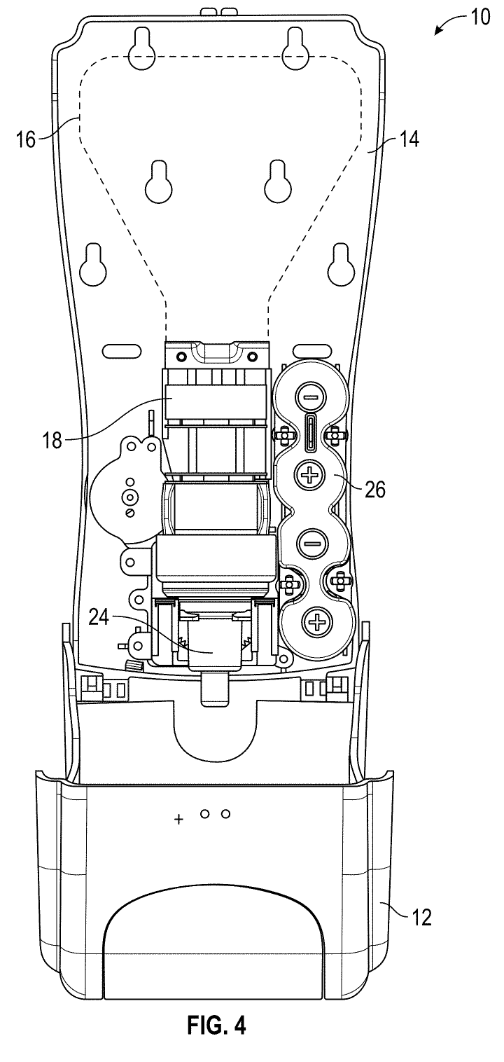

Referring now to FIGS. 1-4, one non-limiting embodiment of a dispenser is shown schematically at 10. The dispenser 10 is configured to store and dispense dispensable materials, such as for example, liquids, solids and powders. The dispenser 10 includes a dispenser cover 12 configured to cover a dispenser base 14. The dispenser cover 12 is rotatable from a closed orientation as shown in FIG. 1 to an open orientation as shown in FIGS. 2-4.

Referring again to FIGS. 1-4, the dispenser 10 also includes a reservoir, shown schematically at 16, a pump/valve mechanism 18, a controller 20, a sensing mechanism (not shown for purposes of clarity), an optional display device 22, an output structure 24 and a power supply 26.

Referring now to FIG. 1, the dispenser cover 12 is configured to support the controller 20 and the display device 22, substantially cover the dispenser base 14 and the components contained within the dispenser base 14. The dispenser cover 12 includes a cover aperture 28 configured to allow exposure of the optional display device 22. The display device 22 will be discussed in more detail below. The dispenser cover 12 can have any desired shape, contours, size or configuration and can be made from any desired material or materials sufficient to support the controller 20 and the display device 22, cover the dispenser base 14 and the components contained within the dispenser base 14.

Referring now to FIGS. 2-4, the dispenser base 14 is configured to support the reservoir 16, pump/valve mechanism 18, sensing mechanism and the output structure 24. The dispenser base 14 can have any desired shape, size or configuration and can be made from any desired material or materials sufficient to support the reservoir 16, pump/valve mechanism 18, sensing mechanism and the output structure 24.

Referring again to FIGS. 2-4, the reservoir 16 is configured to store dispensable materials (not shown) and release the dispensable materials upon demand. In certain embodiments, the reservoir 16 can be a pouch or bag. Alternatively, the reservoir 16 can be any structure, such as for example a canister or collapsing semi-rigid bottles, configured to store and release dispensable materials. The dispensable materials can be any desired material or combination or desired materials and can have any form. Non-limiting examples of dispensable material forms include liquids, solids, powders and aerosols. Non-limiting examples of dispensable materials include skin cleaners, hair washes, skin lotions, detergents, softeners, bleaches, sanitizers, degreasers, finishes, strippers, glass cleaners and disinfectants.

While the embodiment illustrated in FIGS. 1-4 show a lone reservoir 16, it should be appreciated that in other embodiments, more than one reservoir can be incorporated into the dispenser 10.

Referring again to FIGS. 2-4, the pump/valve mechanism 18 connects the reservoir 16 with the outlet structure 24. The pump/valve mechanism 18 is configured to receive an activation signal from the controller 20 and release a metered amount of dispensable material to the outlet structure 24. Pump/valve mechanisms 18 are known in the art and any suitable pump/valve mechanism 18 can be used.

Referring again to FIGS. 2-4, the outlet structure 24 is connected to the pump/valve mechanism 18 and includes an aperture (not shown) through which the dispensable material exits the dispenser 10. The outlet structure 24 can have any desired shape, size and configuration sufficient to allow dispensable material to flow from the pump/valve mechanism 18 and exit the dispenser 10.

Referring again to FIGS. 2-4, the controller 20 is in communication with the sensing mechanism, the pump/valve mechanism 18 and optionally the display device 26. The controller 20 is configured for several functions. First, the controller 20 is configured to receive activation signals from the sensing mechanism or other signal generators, such as the non-limiting example of a manually operated actuator (not shown). Upon receiving an activation signal, the controller 20 is configured to generate and send dispensing signals to the pump/valve mechanism 18, thereby instructing the pump/valve mechanism 18 to release a metered amount of dispensable material to the outlet structure 24. As the pump/valve mechanism 18 is releasing the dispensable material, the controller 20 can be configured to simultaneously generate and send signals to the display device 22. The display device 22 can, in turn, display approved messages.

In the illustrated embodiment, the controller 20 is a microprocessor-based device sufficient to provide the functions discussed above. However, in other embodiments, the controller 20 can be any suitable device sufficient to provide the functions discussed above.

Referring again to FIGS. 2-4, the sensing mechanism (not shown) is configured to generate activation signals upon the occurrence of an activating event. Non-limiting examples of activation events can include sensing the presence of a person or object. Sensing mechanisms are known in the art and any suitable sensing mechanism can be used.

Referring again to FIGS. 2-4, the power supply 26 is configured to provide electrical power to the pump/valve mechanism 18 and to the controller 20. The power supply 26 will be discussed in more detail below.

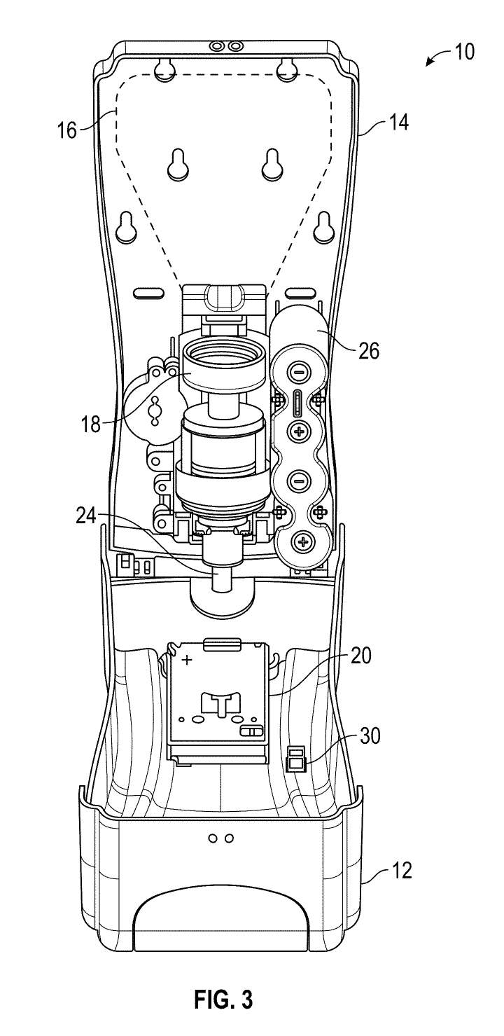

Referring now to FIG. 3, a bridge 30 is connected to the dispenser cover 12. Generally, the bridge 30 is configured such that with the dispenser cover 12 in a closed orientation, the bridge 30 electrically engages elements of the power supply 26, thereby permitting the power supply 26 to provide electrical power to the pump/valve mechanism 18 and to the controller 20. The bridge 30 is further configured such that with the dispenser cover 12 in an open orientation, the bridge 30 is not engaged with elements of the power supply 26, thereby rendering the dispenser 10 inoperative. The bridge 30 will be discussed in more detail below.

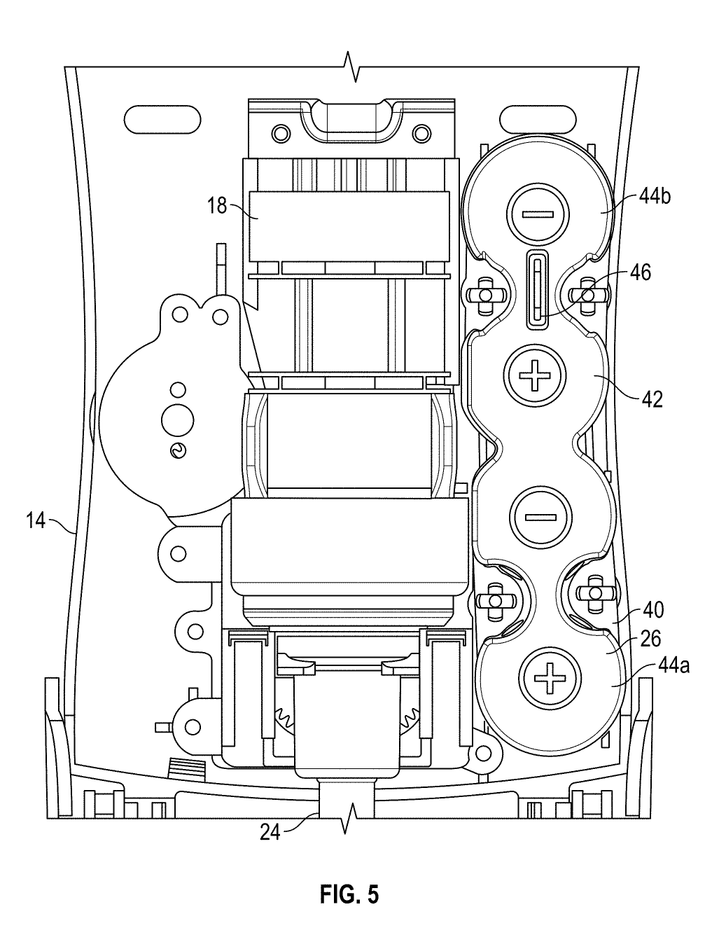

Referring now to FIG. 5, a portion of the dispenser base 14 is illustrated showing the power supply 26. The power supply 26 includes a power supply base 40, a power supply cover 42, one or more power supply cells 44a, 44b and internal wiring (not shown). The power supply base 40 is configured to support the power supply cover 42, the power supply cells 44a, 44b and the internal wiring. The power supply base 40 can have any desired shape, size or configuration and can be made from any desired material or materials sufficient to support the power supply cover 42, the power supply cells 44a, 44b and the internal wiring.

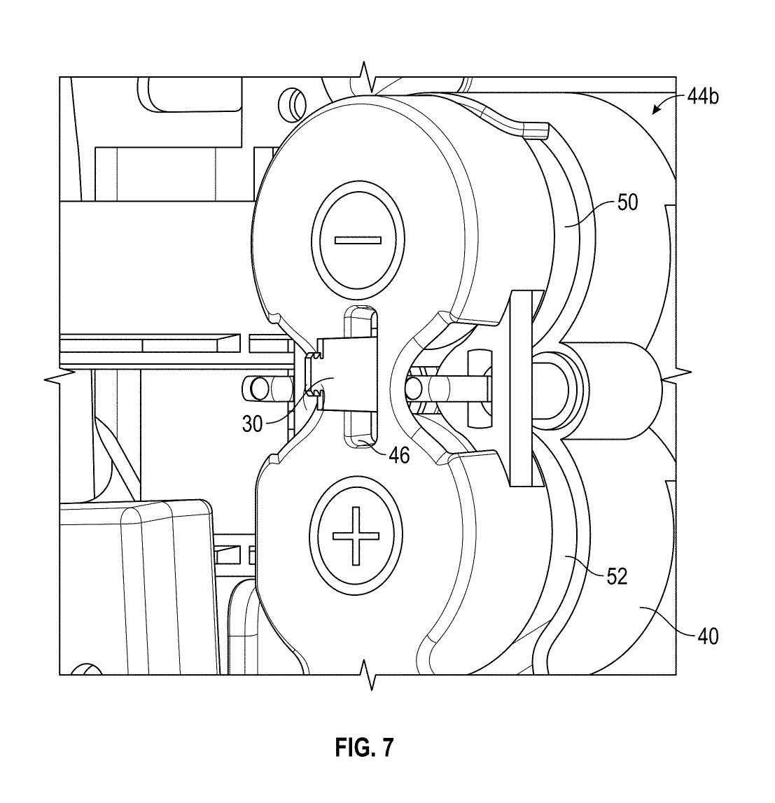

Referring again to FIG. 5, the power supply cover 42 is configured to substantially enclose the power supply base 40, the power supply cells 44a, 44b and the internal wiring. The power supply cover 42 includes a power supply aperture 46. Referring now to FIG. 7, the power supply aperture 46 is configured to receive the bridge 30 connected to the dispenser cover 12 such that the bridge 30 extends through the power supply cover 42 and electrically engages the power supply cells 44a, 44b. In the embodiment illustrated in FIG. 7, the power supply aperture 46 has a rectangular cross-sectional shape. However, in other embodiments, the power supply aperture 46 can have other cross-sectional shapes, sufficient to receive the bridge 30 and allow the bridge 30 to extend through the power supply cover 42 and electrically engage the power supply cells 44a, 44b. The power supply cover 42 can have any desired shape, contours, size or configuration and can be made from any desired material or materials sufficient to substantially enclose the power supply base 40, the power supply cells 44a, 44b and the internal wiring.

Referring again to FIG. 5, the power supply 26 is illustrated with a quantity of two (2) power supply cells 44a, 44b. However, it should be appreciated that in other embodiments, the power supply 26 can be configured with any suitable quantity of power supply cells.

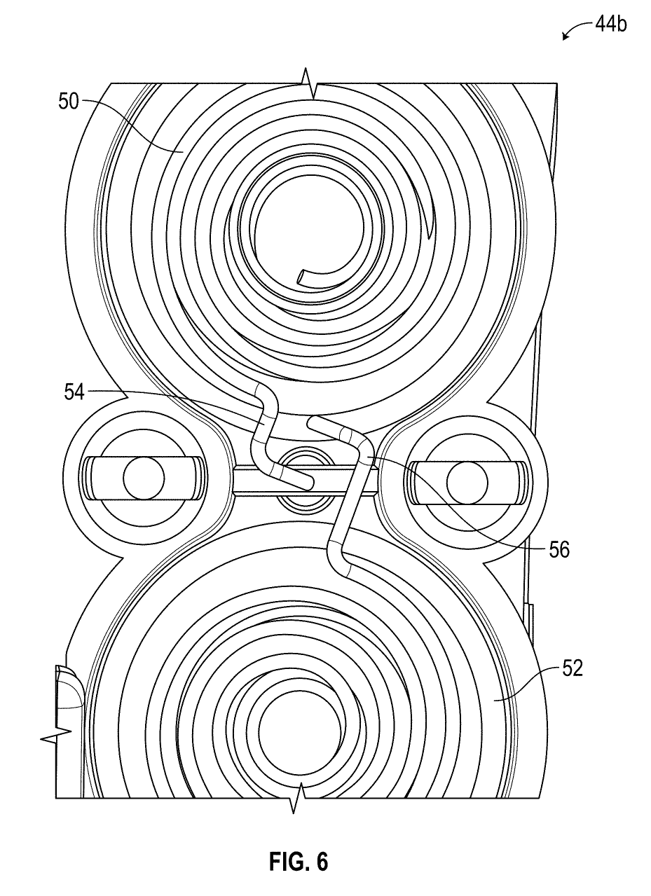

Referring now to FIG. 6, power supply cell 44b is illustrated without the power supply cover 42. The power supply cell 44b includes a cathode portion 50 and an anode portion 52. The cathode portion 50 is electrically connected to a cathode connector 54 and the anode portion 52 is electrically connected to an anode connector 56. The cathode and anode connectors 54, 56 are formed from an electrically conductive material.

Referring now to FIG. 7, power supply cell 44b is illustrated having the cathode portion 50 and the anode portion 52 extending from the power supply base 40. The power supply cover 42, having the power supply aperture 46, substantially covers the cathode portion 50 and the anode portion 52. The bridge 30, shown disconnected from the dispenser cover 12 for purposes of clarity, is received by the power supply aperture 46 and extends through the power supply aperture 46 to electrically engage the cathode portion 50 and the anode portion 52. As discussed above, the bridge 30 is received by the aperture 46 in the power supply cover 42 when the dispenser cover 12 is in a closed orientation.

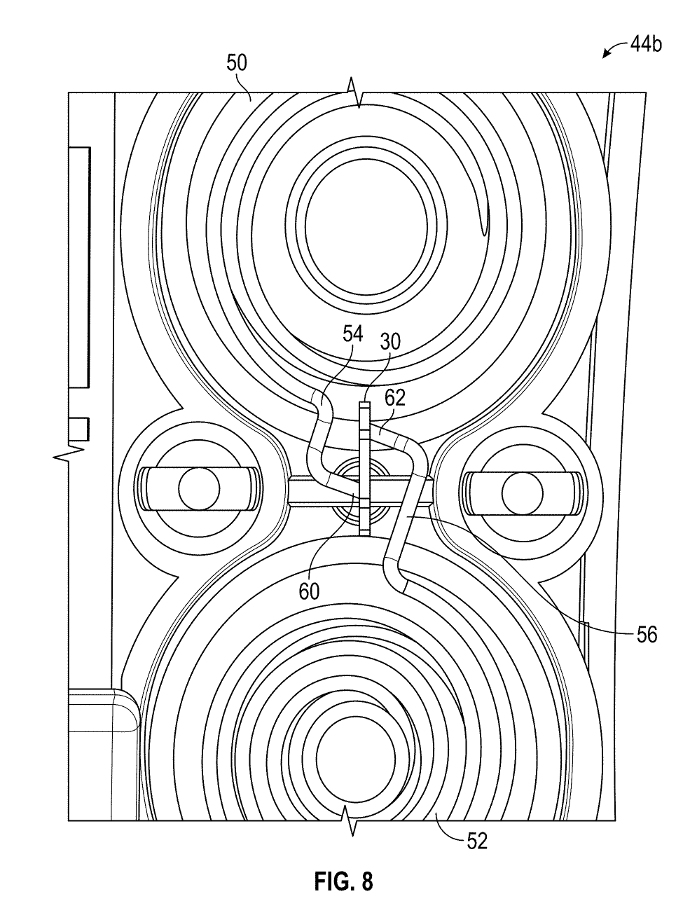

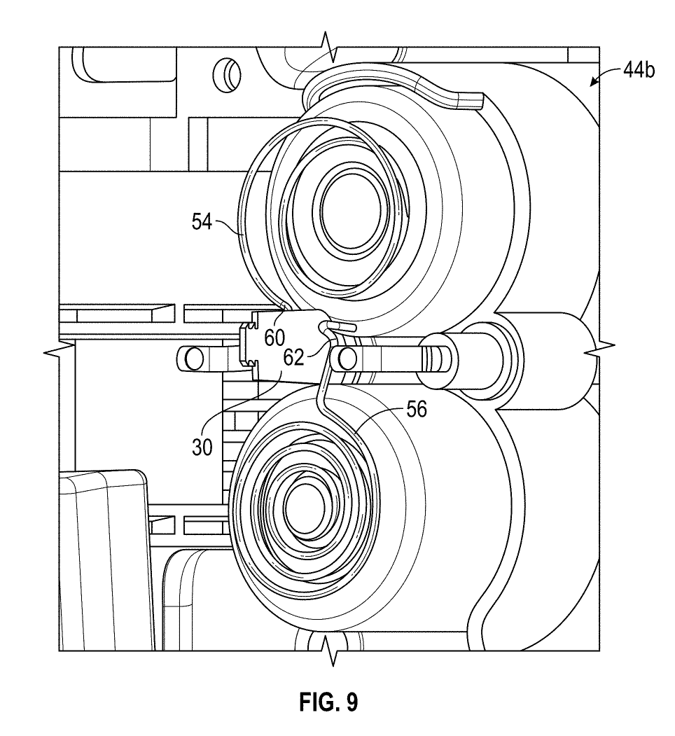

Referring now to FIGS. 8 and 9, the bridge 30 is illustrated in electrical contact with the cathode connector 54 and the anode connector 56. With the bridge 30 electrically contacting both the cathode connector 54 and the anode connector 56, the electrical circuit between the cathode portion 50 and the anode portion 52 of the power supply cell 44b is completed and the cell 44b is enabled to provide electrical power to the pump/valve mechanism 18 and to the controller 20.

Referring again to FIG. 9, the bridge 30 is formed from an electrically conductive material, such as the non-limiting examples of brass or steel. However, it should be appreciated that in other embodiments, the bridge 30 can be formed from other electrically conductive materials, such as for example, conductive polymers. While the bridge 30 is illustrated in FIG. 9 as having a blade shape with substantially flat, opposed major sides, it should be appreciated that the bridge 30 can have other shapes sufficient to contact both the cathode connector 54 and the anode connector 56 and complete the electrical circuit between the cathode portion 50 and the anode portion 52.

Referring again to FIGS. 8 and 9, the cathode connector 54 has a cathode connector first end 60 and the anode connector 56 has an anode connector first end 62. The first ends 60, 62 are configured for slidable contact with the opposed major sides of the bridge 30. In the illustrated embodiment, the first ends 60, 62 have an arcuate shape, sufficient to facilitate slidable electrical contact with the opposed major sides of the bridge 30 as the dispenser cover 14 is closed and the bridge 30 is inserted into position between the cathode connector 54 and the anode connector 56. The arcuate shape of the first ends 60, 62 is further configured to permit slidable disengagement of the bridge 30 as the dispenser cover 14 is opened. In alternate embodiments, the first ends 60, 62 can have other shapes or can include other structures, sufficient to facilitate slidable electrical contact with the opposed major sides of the bridge 30 as the dispenser cover 14 is closed and also facilitate slidable disengagement of the bridge 30 as the dispenser cover 14 is opened.

Referring again to FIG. 2, as the dispenser cover 12 is rotated in a direction away from the dispenser base 14, the bridge (not shown) disengages from the power supply 26. Accordingly, with the dispenser cover 12 in an open orientation, the cathode and anode connector are electrically uncoupled, as shown in FIG. 6, as the power supply 26 is rendered inoperable.

Referring again to FIG. 2, a major axis A-A of the dispenser cover 12 and a major axis B-B of the dispenser base 14 form an angle α. In certain embodiments, the bridge 30 can be configured to electrically uncouple the cathode connector 54 and the anode connector 56 when the angle α is small, such as non-limiting example of about 5°. However, it should be appreciated that in other embodiments, the bridge 30 can be configured to electrically uncouple the cathode connector 54 and the anode connector 56 when the angle α is larger or smaller than about 5°.

The open cover detector discussed above provides many advantages, however all advantages may not be present in all embodiments. First, since the bridge 30 engages the cathode connector 54 and the anode connector 56 within the power supply enclosure 40, the open cover detector is substantially unaffected by environmental conditions. Second, the open cover detector is very reliable provided the dispenser cover 12 is rotatable relative to the dispenser base 14. Third, the dispenser 10 is rendered electrically inoperative in the event the dispenser cover 12 is in an open orientation, thereby preventing unwanted dispensing of the dispensable material. Fourth, any quantity of cells can be included within the power supply 26 and wired into the bridge 30 connection. Finally, the open cover detector provides an inexpensive electrical interlock.

While the open cover detector has been described above in the context of a dispenser, it is contemplated that the open cover detector can be configured for other applications requiring an electrical interlock.

The principle and mode of operation of the dispenser incorporating an open cover detector has been described in certain embodiments. However, it should be noted that the dispenser incorporating an open cover detector may be practiced otherwise than as specifically illustrated and described without departing from its scope.

What is claimed is:

1. An open cover detector for a dispenser, comprising:
a cathode connector electrically connected to a cathode of a dispenser power supply;
an anode connector electrically connected to an anode of a dispenser power supply; and
a bridge configured to electrically connect the cathode connector to the anode connector with a dispenser cover in a closed orientation and further configured to electrically disconnect the cathode connector from the anode connector with a dispenser cover in an open orientation.

2. The open cover detector of claim 1, wherein in a closed orientation the bridge is configured to extend through an aperture located in a dispenser power supply cover.

3. The open cover detector of claim 1, wherein the bridge has a blade shape with substantially flat, opposed major sides.

4. The open cover detector of claim 1, wherein in an open orientation, a major axis of the dispenser cover and a major axis of the dispenser base form an angle of about 5°.

5. The open cover detector of claim 3, wherein the substantially flat, opposed major sides of the bridge are configured for slidable contact with the cathode connector and the anode connector.

6. A method of operating an open cover detector for a dispenser, the method comprising the steps of:
electrically connecting a cathode connector to a cathode of a dispenser power supply;
electrically connecting an anode connector to an anode of a dispenser power supply; and
closing a dispenser cover, the dispenser cover having a bridge, such that the bridge electrically connects the cathode connector to the anode connector;
opening the dispenser cover such that the bridge electrically disconnects the cathode connector from the anode connector.

7. The method of claim 6, including the step of extending the bridge through an aperture located in a dispenser power supply cover with the dispenser cover in a closed orientation.

8. The method of claim 6, wherein the bridge has a blade shape with substantially flat, opposed major sides.

9. The method of claim 6, wherein in an open orientation, a major axis of the dispenser cover and a major axis of the dispenser base form an angle of about 5°.

10. The method of claim 8, wherein the substantially flat, opposed major sides of the bridge are configured for slidable contact with the cathode connector and the anode connector.

11. A dispenser incorporating an open cover detector, the dispenser comprising:
a dispenser base configured to support a dispenser power supply;
a dispenser cover connected to the dispenser base and configured for pivoting movement in a direction away from the dispenser base thereby forming an open orientation and further configured for pivoting movement in a direction toward the dispenser base thereby forming an closed orientation;
an open cover detector configured to engage the dispenser power supply with the dispenser cover in the closed orientation and further configured to disengage the dispenser power supply with the dispenser cover in an open orientation, the open cover detector including a cathode connector electrically connected to a cathode of a dispenser power supply and an anode connector electrically connected to an anode of a dispenser power supply, the open cover detector further including a bridge configured to electrically connect the cathode connector to the anode connector with a dispenser cover in the closed orientation and further configured to electrically disconnect the cathode connector from the anode connector with a dispenser cover in the open orientation.

12. The dispenser of claim 11, wherein in a closed orientation the bridge is configured to extend through an aperture located in a dispenser power supply cover.

13. The dispenser of claim 11, wherein the bridge has a blade shape with substantially flat, opposed major sides.

14. The dispenser of claim 11, wherein in an open orientation, a major axis of the dispenser cover and a major axis of the dispenser base form an angle of about 5°.

15. The method of claim 13, wherein the substantially flat, opposed major sides of the bridge are configured for slidable contact with the cathode connector and the anode connector.

16. A method of operating a dispenser comprising the steps of:
supporting a dispenser power supply within a dispenser base;
connecting a dispenser cover to the dispenser base and configuring the dispenser cover for pivoting movement in a direction away from the dispenser base thereby forming an open orientation and further configuring the dispenser cover for pivoting movement in a direction toward the dispenser base thereby forming an closed orientation;
positioning the dispenser cover in the closed orientation thereby engaging the dispenser power supply with an open cover detector; and
positioning the dispenser cover in the open orientation thereby disengaging the dispenser power supply with the open cover detector.

17. A method of operating a dispenser of claim 16, wherein the dispenser includes an open cover detector.

18. A method of operating a dispenser of claim 17, wherein the open cover detector includes a cathode connector, an anode connector and a bridge configured to electrically connect the cathode connector to the anode connector with a dispenser cover in the closed orientation and further configured to electrically disconnect the cathode connector from the anode connector with a dispenser cover in the open orientation.

19. The dispenser of claim 18, wherein in a closed orientation the bridge is configured to extend through an aperture located in a dispenser power supply cover.

20. The dispenser of claim 16, wherein in an open orientation, a major axis of the dispenser cover and a major axis of the dispenser base form an angle of about 5°.
